(19) United States
(12) Patent Application Publication
(10) Pub. No.: US 2007/0250803 A1
(43) Pub. Date: Oct. 25, 2007

(54) High-level synthesis method and high-level synthesis system

(76) Inventors: Dai Hattori, Shiga (JP); Keiichi Kurokawa, Hyogo (JP); Yuichiro Ishikawa, Osaka (JP)

Correspondence Address: MCDERMOTT WILL & EMERY LLP, 600 13TH STREET, NW, WASHINGTON, DC, 20005-3096, US

(21) Appl. No.: 11/785,800

(22) Filed: Apr. 20, 2007

(30) Foreign Application Priority Data
Apr. 20, 2006 (JP) 2006-116708

(51) Int. Cl. G06F 17/50

(52) U.S. Cl. 716/18

(57) ABSTRACT

The present invention generates a register transfer level description from a behavior description based on a result obtained by referring to a data path template wherein definition is given with respect to; a group of functional units where a generating method of a circuit in a register transfer level is defined; and a connection relationship of signals between each of functional units that constitute the group of functional units.

### BACKGROUND OF THE INVENTION

1. Field of the Invention

The present invention relates to a high-level synthesis method and a high-level synthesis system, wherein a behavior description of a circuit is made as an input to output a register transfer level description.

2. Description of the Related Art

In accordance with the highly-network information society and the advanced information technology for supporting it, information-processing functions of electronic apparatuses have been tremendously increased. In order to achieve the information processing functions, large-scale integrated circuits play the key role in those electronic apparatuses. As a design technique to design a large-scaled circuit in a short term with less work efficiencies, a research and development has been carried out on a technique for synthesizing circuits with a help of software from the high-level design information where the abstract characteristic is enhanced. As one of circuit synthesis techniques, a high-level synthesis technique is proposed that generates a register transfer level description from a behavior description, as shown in Non-Patent Literature 1, and the like.

In a behavior description of a conventional high-level synthesis technique, only the processing content from the input to the output of the circuit is defined, and the time required for the processing (number of cycles) is not defined. In the meantime, the time required for the processing (number of cycles) is defined in a register transfer level description, since the register of the circuit is determined. In the conventional high-level synthesis technique, a register transfer level circuit with the structure shown in FIG. 16 is generated from a behavior description that is written with high-level languages such as C/C++, etc.

In FIG. 16, reference numerals a1, a2 are hardware (HD) resources as an operation device or a storage device, a3 is a switch box with N-inputs and N-outputs, a4, a5 are signal lines from the switch box a3 to the hardware resources a1, a2. Reference numerals a6, a7 are signal lines from the hardware resources a1, a2 to the switch box a3, a8 is a finite-state machine for controlling the switch box a3, and a9 is a signal line for connecting between the finite-state machine a8 and the switch box a3. The switch box 3a forms a connection network between the hardware resources a1 and a2, and the path, that turns effective in accordance with a signal supplied from the finite-state machine a8, is determined by the switch box a3.

In the conventional high-level synthesis technique, the execution state of each operation of the behavior description is determined (scheduled), and the operations executed under different states are assigned to the same hardware resource (shared) thereafter. At last, the connection network between the hardware resources is generated as a switch box, and a control circuit for controlling the switch box is generated. Herewith, the register transfer level circuit shown in FIG. 16 is generated.

The connection network of the generated register transfer level circuit is determined with the optimizing method of scheduling and sharing. If the search for the optimization of sharing and the like is focused simply on improving the circuit performance and the area with disregard to the complication of the connection network, the connection network to be generated may become extremely complicated. Therefore, there are many cases where it becomes difficult for users who use the high synthesis technique to comprehend the generated register transfer level circuit. If so, it becomes difficult to find out the reasons when a desired performance or area cannot be obtained in the generated register transfer level circuit, which may result in an increase in the designing term due to an increase in the analyzing time, or may not be able to obtain a desired register transfer level circuit.

Further, since only the circuit structure of FIG. 16 can be generated by the conventional high-level synthesis technique, primarily, a high-level synthesis technique can only be applied to the case of the behavior description that can achieve the desired performance and area in the same circuit structure.

As disclosed in the Non-Patent Literature (“A Behavioral Synthesis Method Considering Complex Operations”, SADAKATA, MATSUNAGA, DA Symposium 2004) or the like, there are cases where, since the number of necessary resources is reduced by defining the hardware resources (complex operation resource) that can execute a plurality of operations within the behavior description, collaterally, complication of the connection network of the generated register transfer level circuit may be eased to some extent.

In a method exemplified in Japanese Published Patent Literature (Japanese Unexamined Patent Publication 2001-202397), it is possible to select any IPs from registered IPs (Intellectual Properties) such as a processor, a memory, and hardware (customized hardware) for carrying out customized processing, and to define the connection between the selected IPs as a template. By selecting only the IPs of the customized hardware, it is possible to generate the circuit structures other than the one shown in FIG. 16.

However, it does not change the fact that the connection network is determined as a result of optimization in the method using the complex operation resource. Thus, it cannot expect to ease the complication of the circuit substantially. Further, in the method using IPs, it is assumed that the individually customized hardware is generated by the conventional high-level synthesis method. Therefore, it does not change the fact that the individually customized hardware has the circuit structure of FIG. 16, i.e. the circuit structure with a complicated connection network.

In these conventional methods, when the complication level of the behavior model as the input increases, the connection network of the hardware resource becomes more complicated. Accordingly, in the case where a complicated model, which has a plurality of behaviors that are not executed simultaneously, is the input, generated is a register transfer level circuit with still more complicated connection network.

### SUMMARY OF THE INVENTION

The main object of the present invention therefore is to make it possible to generate a register transfer level circuit in a structure that can be easily comprehended by a user in circuit analysis. Further, the object is to make it possible to generate a register transfer level circuit capable of achieving various performances that are considered difficult to be dealt in the conventional high-level synthesis methods.

The high-level synthesis method of the present invention generates a register transfer level description from a behavior description based on a result obtained by referring to a data path template which defines: a group of functional units that define a generating method (mounting method) of a circuit with a register transfer level; and a relationship of signal connections between each of functional units that constitute the group of functional units.

The behavior description may be the one where a plurality of behaviors, that are not executed simultaneously, is described.

The functional units may be the one where the at least one of an operation device, a storage device and an external I/F (Interface) that are mounting targets as register transfer level respectively, and a synthesis rule for generating the register transfer level description from the behavior description, are defined.

Further, it may be constituted so that the operation device has a plurality of exclusive functions, and the functional unit having the operation device can be corresponded to a plurality of sections in the behavior description.

Furthermore, the storage device may be any one of a memory, a register file (register group), and an FIFO (First-in-First-out) register.

Further, the external I/F may be one of no-handshake type (no synchronization), one-directional handshake type, or bidirectional handshake type. Furthermore, a control method of a circuit generated in the register transfer level description may be defined as the synthesis rule.

Moreover, the control mode defined in the synthesis rule may be any one of a sequential processing mode, a pipeline processing mode, or no-control mode.

Further, in the case where the register transfer level is written based on the behavior description, the present invention may comprise the steps of:
a step for dividing the behavior description into partial behavior descriptions;
a step for corresponding the partial behavior descriptions to the functional units within the data path template; and
a step for generating the register transfer level description from the partial behavior descriptions every functional unit.

Furthermore, in the case where the register transfer level description is generated from a behavior descriptions including a plurality of behaviors that is not executed simultaneously, the present invention may comprise the step of:
a step for dividing the behavior description into partial behavior descriptions by each of the plurality of behaviors that are not executed simultaneously;
a step for corresponding the partial behavior descriptions to the functional units within the data path template;
a step for binding a plurality of the partial behavior descriptions into a single partial behavior description, when there are a plurality of the partial behavior descriptions that are corresponded to the functional unit; and
a step for generating the register transfer level description from the bound partial behavior description.

Moreover, the present invention may further comprise a step for selecting one of the data path templates as the data path template to be referred, selecting at least one of a processing cycle number, area and power consumption, as an index, from a data path template library where a plurality of the data path templates are registered.

The high-level synthesis system of the present invention comprises:
a data path template library where data path templates defining a group of functional units that define a generating method of a circuit in a register transfer level, and a connection relationship of signals between each of functional units that constitute the group of functional units, are registered in advance;
a selector for selecting the data path template from the data path template library;
a first input device to which the behavior description is inputted; and
a first generator which generates a register transfer level description from the data path template selected by the selector and the behavior description inputted to the first input device.

It is preferable for the first generator to comprise:
a divider for dividing the inputted behavior description into partial behavior descriptions;
a corresponding device for corresponding the partial behavior descriptions to the functional units; and
a second generator for generating the register transfer level description from the partial behavior descriptions.

It is preferable to further comprise a binding device for binding a plurality of partial behavior descriptions into a single partial behavior description, when there is a plurality of partial behavior descriptions that are responded to the functional unit.

It is preferable to further comprise a register for allowing a user to register a new data path template to the data path template library.

It is preferable that the present invention further comprise:
a behavior data displaying device for displaying the behavior description, and
a data path template displaying device for displaying the data path template selected, wherein:
the partial behavior description is selected by a user based on displayed contents of the behavior data displaying device;
the functional unit is selected by the user based on displayed contents of the data path template displaying device; and
the selected partial behavior description and the selected functional unit are responded to each other.

Further, it is preferable that the present invention comprise a data path template displaying device for displaying the selected data path template, and
a register transfer level data displaying device for displaying the generated register transfer level description, wherein
when the functional unit is selected based on displayed contents of the data path template displaying device, the register transfer level data displaying device highlight-displays a partial description of the register transfer level description which corresponds to the selected functional unit.

Furthermore, it is preferable to further comprise:
a second input device for inputting a simulation result of the generated register transfer level description; and
a data path template displaying device for displaying behavior of the functional unit at a designated time.

In the high-level synthesis method of the present invention, the following effects can be obtained.

1) The user defines the circuit structure of the register transfer level with the data path template so that it is possible to generate the register transfer level circuit with such a structure that can be easily comprehended by the user. As a result, the simplicity of analyzing the generated register transfer level circuit is improved, and thereby it is possible to obtain a register transfer level circuit that has the performance (the processing capacity, the area) intended by the user within a short term.
2) Through providing the data path templates, it is possible to generate the register transfer level circuits with various structures that are different from those obtained by the conventional high-level synthesis methods. Therefore, the method of the present invention can be applied to such behavior models that cannot generate the register transfer level circuit to achieve a desired performance in the conventional high-level synthesis methods.

Furthermore, in addition to the above-described effects, it is possible to obtain the following effects in the high-level synthesis system of the present invention.

### 3) Since the displaying devices display the behavior model, data path template and the relation with the circuit, the simplicity of analyzing the circuit can be more improved.

### 4) Through registering the circuit structure as a library, it is possible to reuse the circuit resources of the past.

As described above, the high-level synthesis method and the high-level synthesis system of the present invention generate the RTL description having the same circuit structure as in the data path template designated by the user. Therefore, it is possible to generate the RTL description that is provided with a desired performance and formed in a structure that can be easily comprehended by the user. The present invention with such features can be widely utilized for designing large-scale integrated circuits.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention.

FIG. 1 is a flowchart of a high-level synthesis method according to a first embodiment of the present invention;

FIG. 2 is a constitutive diagram of a high-level synthesis system according to the first embodiment of the present invention;

FIG. 3 is an example of description in a data path template file;

FIG. 4A and FIG. 4B are examples of description in a behavior description file;

FIG. 5 is a data structural example of behavioral unit data;

FIG. 6 is an example of a corresponding table of the behavioral unit data and the data path template;

FIG. 7A and FIG. 7B are data structural examples of bound behavior data;

FIG. 8 is a description example of an RTL description file;

FIG. 9 is a flowchart of a data path template selection method according to a second embodiment;

FIG. 10A and FIG. 10B are examples of performance parameter calculation according to the second embodiment of the present invention;

FIG. 11 is a constitutive diagram of a high-level synthesis system according to a third embodiment of the present invention;

FIG. 12 is a display example of a behavior data displaying device;

FIG. 13 is a display example of a data path template displaying device;

FIG. 14 is a display example of an RTL displaying device;

FIG. 15A, FIG. 15B, and FIG. 15C are display examples of the data path template displaying device; and

FIG. 16 is a circuit structure generated by a conventional high-level synthesis technique.

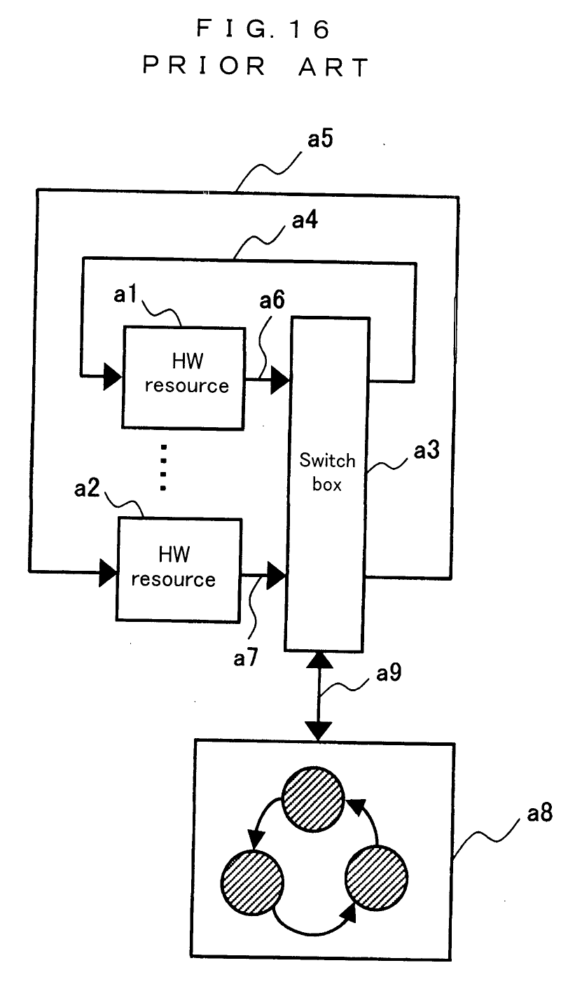

### DETAILED DESCRIPTION OF THE INVENTION

Hereinafter, embodiments of the high-level synthesis method and high-level synthesis system according to the present embodiment will be described in detail referring to the accompanying drawings.

### First Embodiment

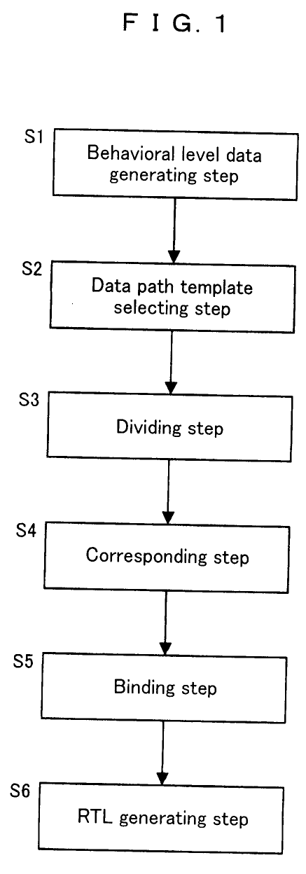

FIG. 1 is a flowchart for showing the processing order of the high-level synthesis method according to the aforementioned first embodiment of the present invention. The high-level synthesis method of the embodiment comprises: a behavior data generating step S1 wherein behavior data is generated from an inputted behavior description file; a data path template selecting step S2 for selecting the data path template; a dividing step S3 wherein the behavior data is divided into the data of an arbitrary behavioral unit; a corresponding step S4 wherein the divided behavioral unit data is responded to the functional units within the data path template; a binding step S5 for binding the divided behavioral unit data that are responded to the same functional unit; and an RTL (Register Transfer Level) generating step S6 wherein RTL data is generated from the behavior data bound by each functional unit, according to the synthesis rule defined in the functional unit.

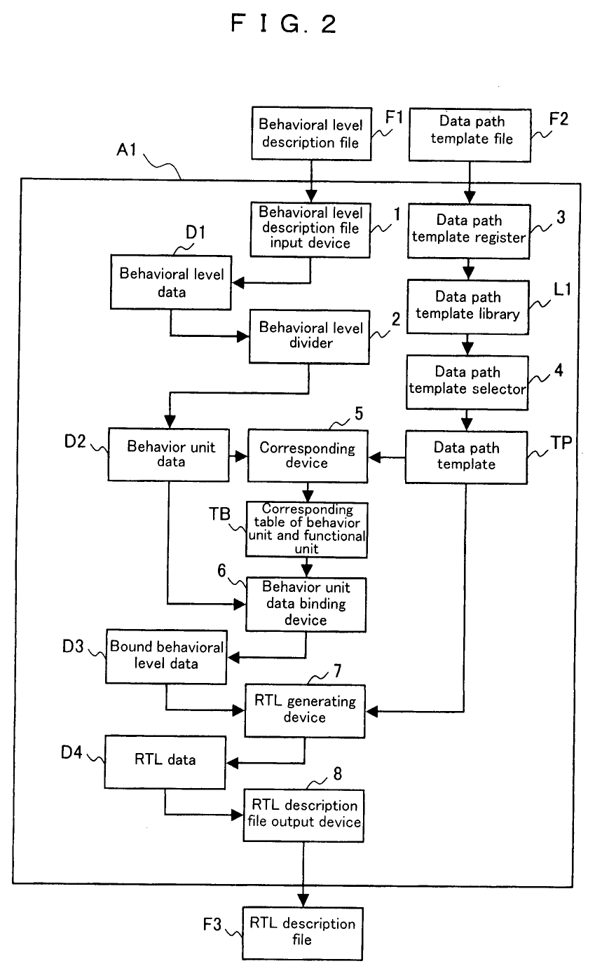

FIG. 2 shows the structure of a high-level synthesis system A1 according to the first embodiment of the present invention. The high-level synthesis system A1 comprises: a behavior description file input device 1 which inputs a behavior description file F1 and generates behavior data D1; a behavior divider 2 which divides the behavior data D1 into the behavioral unit data D2; a corresponding device 5 which responds the behavioral unit data D2 to the functional units within the data path template TP so as to generate a corresponding table TB of the behavioral unit data and the functional units; a behavioral unit data binding device 6 which binds a plurality of pieces of behavioral unit data D2 that are responded to the same functional unit; an RTL generator 7 which generates RTL data D4 from bound behavior data D3; an RTL description file output device 8 which outputs an RTL description file F3; a data path template library L1 where data path templates TP are stored; a data path template register 3 which registers the data path template file 2 to the data path template library L1; and a data path template selector 4 which selects a single data path template TP to be used for high-level synthesis from the data path template library L1.

The behavior description file F1 is a file wherein the circuit to be a target of high-level synthesis is described by a behavior, that is written with a procedural language such as C language or the like. The behavior description file input device 1 reads the behavior description file F1 and generates the behavior data D1. The behavior data D1 has the data structure with which increment points of the function written in the behavior description file F1 can be identified. Further, it is the data that expresses the relation between a plurality of statements based on tree structure with respect to the statements within the function. The behavior data D1 has a one-to-one relation with the description contents of the behavior description file F1.

The behavior divider 2 divides the behavior data D1 into sections designated by the user or divides it into automatically extracted sections in accordance with the data path template to be used, in order to generate the behavioral unit data D2. The behavioral unit data D2 is the data expressing the behavioral unit as a function. Therefore, when the designated section is a function, the behavioral unit data is generated as the same data as the function that corresponds to the behavior data D1. In the meantime, when the designated section is a statement, extracted is a tree structure having the designated statement within the behavior data D1 as the root at the time of dividing the data, and the data is generated as a function including only the extracted tree structure. The behavioral unit data D2 is the data expressing a section in the inputted behavior description file F1, so that it can be considered as a partial behavior description of the behavior description file F1.

The corresponding device 5 generates the corresponding table TB of the functions within the behavioral unit data D2 and the functional units within the data path template TP. The functional units and the functions are in a one-to-many relationship and, this relationship indicates that the processing shown by the function is carried out in that functional unit. In the case where a plurality of functions is responded to a single functional unit, it indicates that the processing shown by those functions is not carried out simultaneously. The corresponding relationship between the functional units and the functions is either designated by the user or generated automatically.

When two or more functions are corresponded to a single functional unit in the corresponding table TB, the behavioral unit data binding device 6 generates the bound behavior data D3 by converting the processing contents shown by those functions into a single function for performing a binding processing of the processing contents through branch processing. When there is one function that corresponds to a single functional unit, the bound behavior data D3 is generated as the same data as the function of the behavioral unit data D2. When there are two or more functions, it is generated as the data of a function that is generated newly by the binding processing. The bound behavior data D3 is the data in which the behavioral unit is expressed as a function, and the function has a one-to-one relationship with the functional unit. As described above, the function and the functional units are converted from one-to-many relationship to one-to-one relationship.

The RTL generator 7 generates the RTL data D4 from the bound behavior data D3 according to the synthesis rule written in the functional unit of the data path template TP. The RTL description file output device 8 outputs the RTL data D4 as an RTL description file F3 that is written with hardware description language such as Verilog language or the like. The data path template register 3 registers the data path template file F2 to the data path template library L1. The data path template selector 4 selects a single data path template TP that is used for synthesizing the RTL data 4 from the behavior description file F1 in the data path template library L1. In the data path template file F2, there are written a connection of the signals between a functional unit and another functional unit and the performance parameters. The performance parameter is written as parameters for calculating the processing cycle number, the area, and the power consumption of the circuit that is generated using the data path template.

In the functional unit, the resources and a single control mode are written that are necessary for generating the RTL data D4 from the function within the behavioral unit data D2 that corresponds to the functional unit. As the resources, there are three types such as a storage resource that is defined in advance, an operation resource and an external I/F resource. There are four types of storage resources, such as a register file resource, a memory resource and a FIFO resource, and the number of necessary resources is written in the functional unit. The operation resource is written in a combination of basic operation devices that correspond to the operators in the behavior data D3 such as an adder, a multiplier, etc. For example, when the behavior description as the input is written with C language, an operation device that is in a one-to-one relationship with the operator defined by C language is defined as the basic operation device in advance. Further, a plurality of exclusive operations can be written in the operation resource. In that case, the operation contents of a control signal and a control signal value are written respectively.

The external I/F resource is a resource that generates a protocol signal of the behavior description as the target of synthesis between the outside. It is written by being selected from “no handshake”, “one-directional handshake”, and bidirectional handshake”, which are defined in advance. The control mode is written based on a single mode selected from a sequential processing mode, pipeline processing mode, and no-control mode, which are defined in advance.

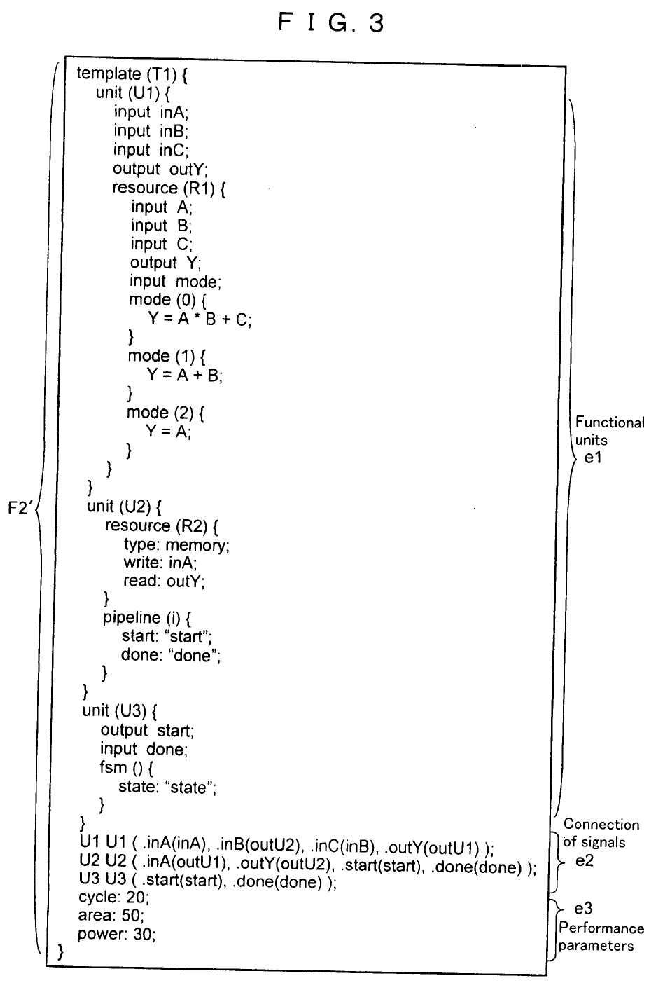

Next, an example of description in the data path template file F2 will be described referring to the drawing. FIG. 3 is an example of the data path template file F2. Written are the functional unit e1, signal connection e2 between the functional units, and performance parameters e3 in the data path template file F2′. A plurality of functional units can be written in the functional unit e1, and connections of the signals are written as the connection e2 between the functional units. A plurality of resources can be written in each functional unit and, in this case, an operation device resource R1 capable of carrying out a plurality of operations is written in a functional unit U1, and a memory resource R2 is written in a functional unit U2. Further, as the control method, the functional unit U1 is written as “no-control mode”, the functional unit U2 is written as “pipeline processing mode”, and the functional unit U3 is written as “sequential processing mode”.

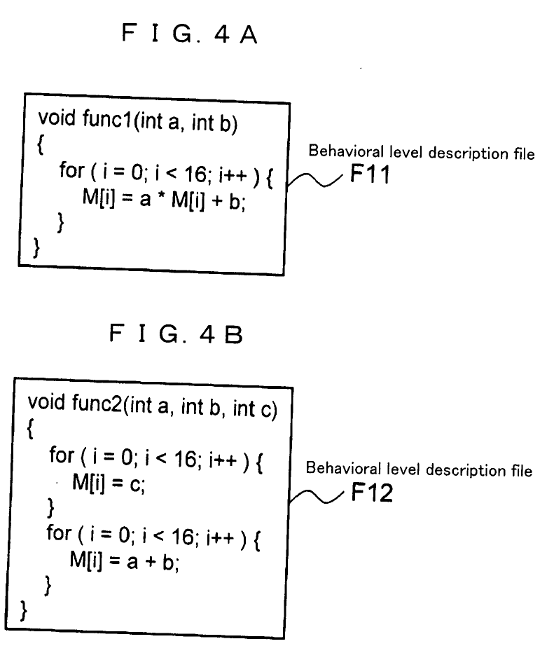

Next, with respect to the high-level synthesis method using the data path template as the first embodiment of the present invention, specifically, the case of having the behavior description shown in FIG. 4A, FIG. 4B as the input, will be described referring to FIG. 1, FIG. 2.

The behavior of the circuit that uses C language is written in FIG. 4A and FIG. 4B, and the behavior description files F11, F12 are separate behaviors that are not executed simultaneously. The behaviors that are not executed simultaneously means that only one of those behaviors can be executed in one-time processing even though all of those behaviors can be done in a single circuit. For example, when there are the circuits that correspond to a plurality of standards such as MPEG 2 and MPEG 4, the behavior of MPEG 2 and that of MPEG 4 are the behavior descriptions that are not executed simultaneously because there is a behavior description for each standard. In this case, the circuit indicated by the generated RTL description is the circuit that can execute the image codec processing based on only one of the standards in one-time processing.

Before starting the processing of the flowchart shown in FIG. 1, the data path template register 3 registers the data path template file F2 to the data path template library L1 as a preparation. Here, the processing will be described, assuming that the data path template file F2′ is registered as the data path template file F2, and the same data path template is selected in the latter step.

First, in the behavior data generating step S2, the behavior description file input device 1 generates the behavior description files F11 and F12 to which the behavior data D1 is inputted. Three functional units U1, U2, and U3 are written in the data path template file F2′. Further, it is written in the functional unit U1 that the operation resource R1 can be used, and it is written in the functional unit U2 that the memory resource R2 can be used. Further, it is written in the control signal mode that the operation resource R1 is capable of executing three exclusive operations.

Next, in the data path template selecting step S2, the data path template selector 4 selects a single data path template TP to be used for synthesis from the data path template library L1. Hereinafter, the processing will be described assuming that, as described earlier, the data path template file F2′ is selected by the user.

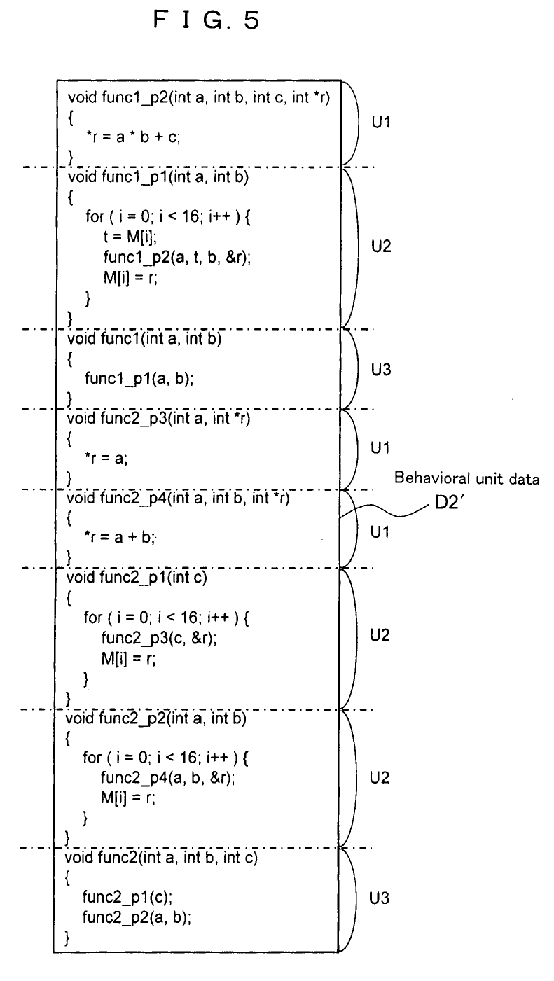

Next, in the dividing step S3, the behavioral unit data D2 is generated through the behavior divider 2 from the behavior data D1 by each section designated by the user. This is the pre-processing for corresponding the behavior data D1 to the functional units that are written in the data path template TP. Except that the user designates the section generating the behavioral unit data D2, it is also possible to generate the behavioral unit data D2 automatically after extracting the resource within the data path template TP from the behavior data D1 by using a technique such as pattern matching or the like. In that case, the operation of the resource R1 within the functional unit U1 is searched from within the behavior data in the data path template file F2′. FIG. 5 is an illustration for schematically depicting the behavioral unit data D2, and the behavioral unit data D2′ is stored in a form of function by each section designated by the user.

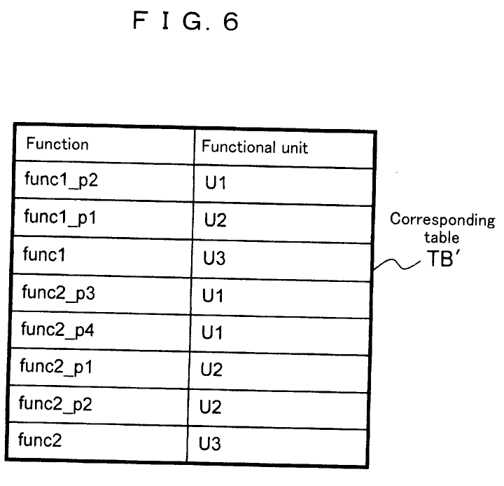

Next, in the corresponding step S4, the corresponding device 5 correlates the functional units within the data path template TP with the functions within the behavioral unit data D2, and generates a corresponding table TB. FIG. 6 shows a corresponding table TB′ showing the case where the data path template file F2′ and the behavioral unit data D2′ are inputted, wherein all the functions within the behavioral unit data D2 are correlated with the functional units.

Furthermore, when the behavioral unit data D2 is automatically generated in the dividing step S3, the corresponding processing is also carried out automatically. Because the behavioral unit data D2 is generated based on the resource within the data path template TP, the behavioral unit data is already corresponded to the function unit. In the case where the behavior data D1 has a plurality of behavior descriptions that cannot be executed simultaneously, the processing until the corresponding step S4 is carried out by each of the behavior descriptions that are not executed simultaneously.

Next, in the binding step S5, the behavioral unit data binding device 6 binds the functions correlated with the functional units respectively so as to generate the bound behavior data D3.

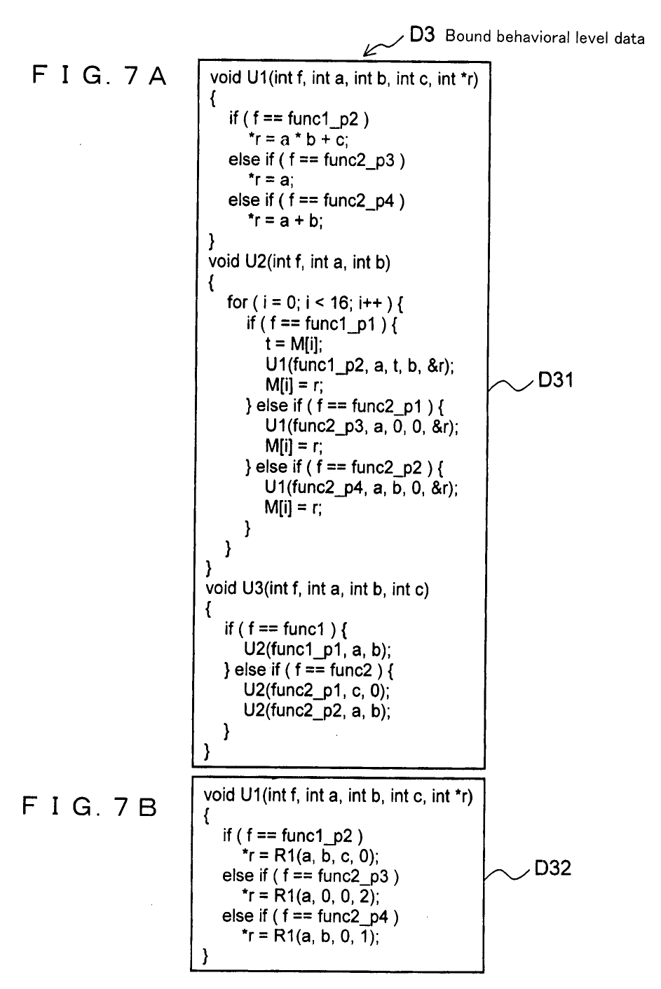

FIG. 7A and FIG. 7B are illustrations schematically depicting the bound behavior data, which show the bound behavior data D31 in the case where the behavioral unit data D2′ and the corresponding table TB′ are inputted. In the bound behavior data D31 is stored in a form of function by each functional unit. The function U1 is a function generated as a result of binding the functions func1_{—}p2, func2_{—}p3, and func2_{—}p4 of the behavioral unit data D2. It is the same for other functions U2 and U3.

Further, when the operation device resource can execute a plurality of exclusive operations, the bound behavior data D3 is stored as the data in a form of using the resource. For example, since the function U1 that corresponds to the functional unit U1 is a functional unit having the resource R1 that is capable of executing a plurality of exclusive operations of the bound behavior data D3, it is stored as the data in a form of using the resource R1 as shown by the bound behavior data D32.

In the case where the dividing step S3 and the binding step S5 are performed based on designation by the user, the target bound behavior data 32 is generated through generating a data flow graph from the function U1 of the bound behavior data D31, extracting a section that matches the operation contents written in the resource R1 from the data flow graph by the use of a technique such as pattern matching or the like, and converting it to a data flow graph using the resource R1.

Next, in the RTL generating step S6, the RTL generator 7 synthesizes the RTL data D4 from the bound behavior data D3 based on a designation of the control mode in the functional unit within the data path template TP so as to generate the RTL description file F3 that is written with the RTL data 4 and a hardware description language.

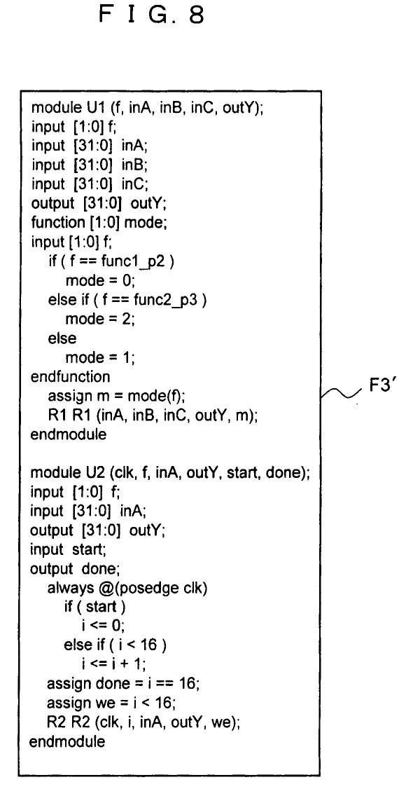

FIG. 8 is a part of an RTL description file F3′ that is generated from the bound behavior data D31 according to the rule of the data path template file F2′. This file is generated as a module by each functional unit written in the data path template file F2′, and generated is an RTL description using the resource used in the functional unit and the written resources R1, R2.

As described above, since it is possible to generate the RTL description file F3 having the circuit structure designated in the data path template TP from the behavior description file F1, the user can obtain the RTL description file within a short term, that has an arbitrary circuit structure that cannot be generated by a conventional high-level synthesis method, while having an easily comprehendible circuit structure. Even when the desired performance is not achieved in one-time synthesis, because the RTL description file F3, that is easily comprehended by the user, is generated, it is easy to analyze the problems, and it is possible to generate the RTL description file F3 with desired performances in a short term through changing the data path template file F2 to be used or through carrying out partial correction, etc. Furthermore, in a plurality of behavior description files F1 that are not carried out simultaneously, it is also possible to generate the RTL description file F3 having the circuit structure that is designated in the data path template TP. Therefore, the same effects can be obtained even in the case where the behavior description file F1 to be inputted becomes complicated.

Furthermore, although the embodiment has been described referring to the case of registering a data path template newly and use this data path template, it is also possible to reuse the data path template through using the data path template registered in the past as it is or by editing a part thereof.

In addition, although the embodiment has been described referring to the case of using a plurality of behavior description files that are not executed simultaneously, it is needles to say that the same effect can be achieved in the case of using a single behavior description file.

### Second Embodiment

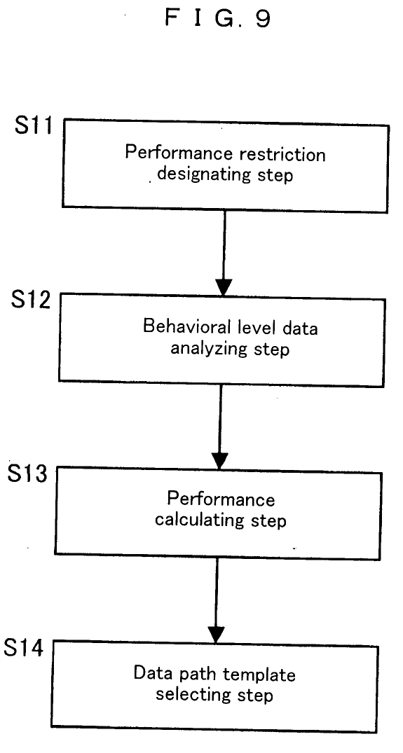

FIG. 9 is an illustration showing the detailed processing order of the data path template selecting step S2 according to the first embodiment described above. The processing except for the data path template selecting step S2 is the same as that of the first embodiment, so that the description thereof is omitted.

The data path template selecting step S2 according to this embodiment comprises steps S11-S14. The step S11 is a performance restriction designating step (referred to as a designating step hereinafter) for designating restriction values for the performances of the register transfer level circuit that the user desires to synthesize, the number of processing cycles, the area and the priority order of the indexes for the power consumption. The step S12 is a behavior data analyzing step (referred to as an analyzing step hereinafter) for calculating the number of operators and the bit width through analyzing the behavior data D1 for the inputted behavior description file F1. The step S13 is a performance calculating step (referred to as a calculating step hereinafter) for calculating the number of processing cycles, the area, and the power consumption in all the data path templates TP that are registered to the data path template library L1 based on the number of operators and the bit width obtained in the analyzing step S12 and the performance parameters written in the data path templates TP. The step S14 is a data path template selecting step (referred to as a selecting step hereinafter) for selecting a single data path templates TP with the minimum index in the priority order designated in the designating step S11 from the data path templates TP that satisfy the restriction values, through comparing the number of processing cycles, the area, the power consumption calculated in the calculating step S13 and the restriction values designated in the designating step S11. In the data path template selecting step S2, the data path template TP to be used for synthesis is selected through these steps S11-S14.

Assuming in the designating step S11 that the user
designates the number of processing cycle as “20”, the area as “50”, and the power consumption as “no restriction”,
designates the priority order of the indexes sequentially as “power consumption>area>processing cycle number”, and
through analyzing the behavior data D1 in the analyzing step S12, the multiplication number N(mul)=4 and the multiplication bit width BW (mul)=8 are obtained
   the processing is carried out as follows.

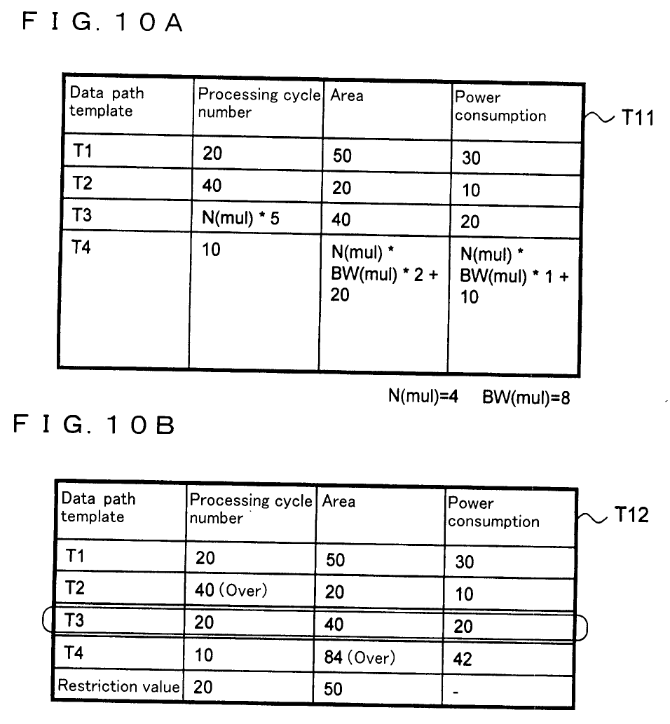

In the calculating step S13, a list table T11 shown in FIG. 10A, is prepared in regard to each of the items written in the data path template, e.g. the processing cycle number, the area, and the power consumption, for each of the data path templates TP registered to the data path template library L1. In the list table T11, the symbols N(mul) and BW(mul) indicate, as described above, the number of multiplications and the multiplication bit width respectively, and it shows that each of the performance values are put into parameters. For example, it means that the number of processing cycles in T3 is five cycles per multiplication. According to this rule, a numerical value list table T12 is formed by using the values obtained in the analyzing step S12.

In the selecting step S14, the list table S12 and the restriction values are compared. Among the data path templates T1 and T3, selected is the data path template T3 where the power consumption with the higher priority order of the indexes, is the minimum restriction value.

As described above, it is possible to automatically select the data path template TP from the data path template library L1, considering the target performances. Therefore, the data path template TP for generating a desired register transfer level circuit can be easily found, when there are many past design resources registered in the data path template library L1. It is needless to say that the user can generate a register transfer level circuit, by editing the selected data path template TP to the one that is more suitable for the purpose.

Further, even in the case of generating a register transfer level circuit by using the automatically selected data path template, it is possible for the user to comprehend the generated RTL description by referring to the selected data path template itself.

### Third Embodiment

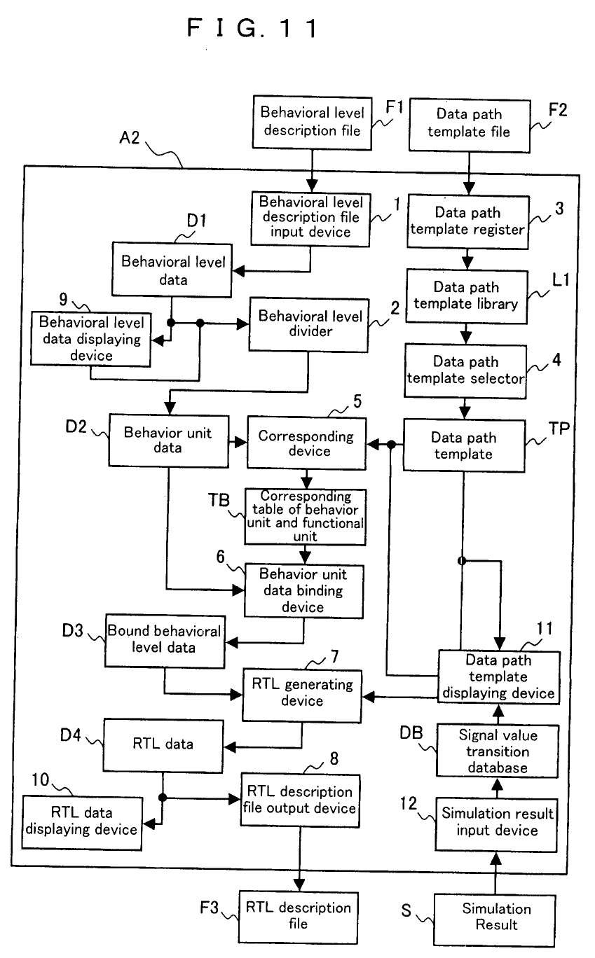

FIG. 11 is an illustration showing the structure of a high-level synthesis system A2 according to a third embodiment of the present invention, that is constituted by adding a behavior data displaying device 9 for displaying the inputted behavior data D1; an RTL data displaying device 10 for displaying the generated RTL data D4; a data path template displaying device 11 for displaying the data path template TP; and a simulation result input device 12 which receives an input of a result S that is obtained by carrying out a dynamic simulation using the generated RTL description file F3 so as to generate a signal value transition database DB based on the inputted values, to the high-level synthesis system A1 shown in FIG. 2. The structures of the behavior description file input device 1, the behavior divider 2, the relating device 5, the behavioral unit data binding device 6, the RTL generator 7, the RTL description file output device 8, the data path template register 3, and the data path template selector 4 are the same as those of the first embodiment described above.

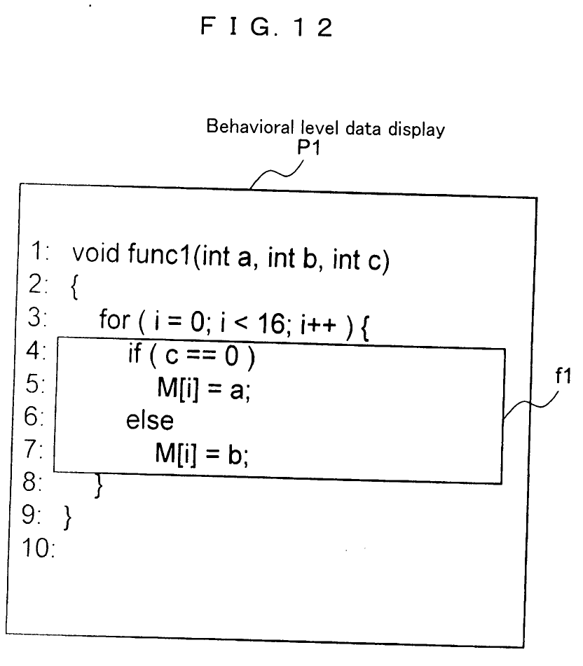

The behavior data displaying device 9 displays the behavior data D1 as the text in the same language as that of the inputted behavior description file F1. For example, when the inputted behavior description file F1 is written by use of C language, the behavior data D1 is displayed as the description based on the C language also in the behavior data displaying device 9. FIG. 12 is an example of the display screen of the behavior data displaying device 9.

The behavior data displaying device 9 is capable of selecting the displayed behavior data D1 by a unit of statement, and a section corresponding to the tree structure having the selected statement of the behavior data D1 as the root is displayed emphatically (highlight display). For example, in the case where the “if statement” on the fourth line of the display screen P1 in FIG. 12 is selected, a selected range f1 that is the tree structure under the “if statement” is the range to be displayed emphatically.

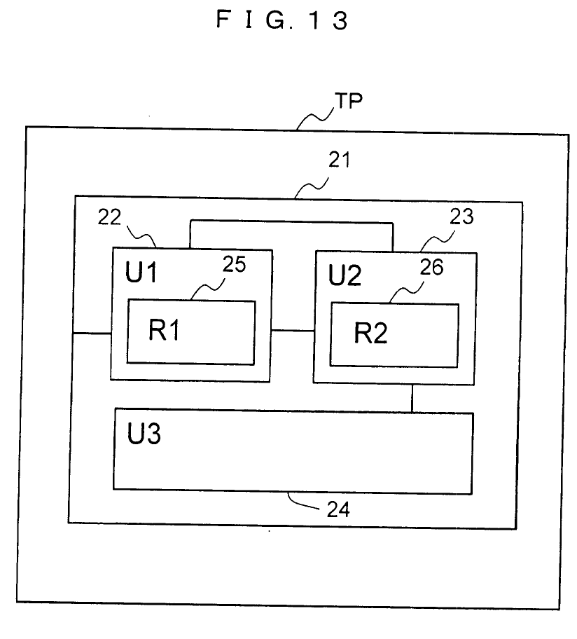

When the user executes the dividing operation to the selected statement, the behavior data D1 is divided, considering the statement selected in the behavior divider 2 as the designated section. The data path template displaying device 11 displays the signal connection between a functional unit and another functional unit of the selected data path template TP as a diagram. FIG. 13 is an example of the display screen of the data path template displaying device 11. This example includes a FIG. 21 showing the entire data path template, and FIGS. 22, 23, and 24 showing the functional units within the data path template TP. Furthermore, in the case where the resources are written within the functional units, FIGS. 25 and 26 showing resources within the functional units 22 and 23, are displayed.

When the user executes a drag-and-drop operation of the statement selected by the behavior data displaying device 9 to the functional units that are displayed on the data path template displaying device 11, the corresponding device 5 correlates the functional units and the functions, and the corresponding relationships are added to the corresponding table TB.

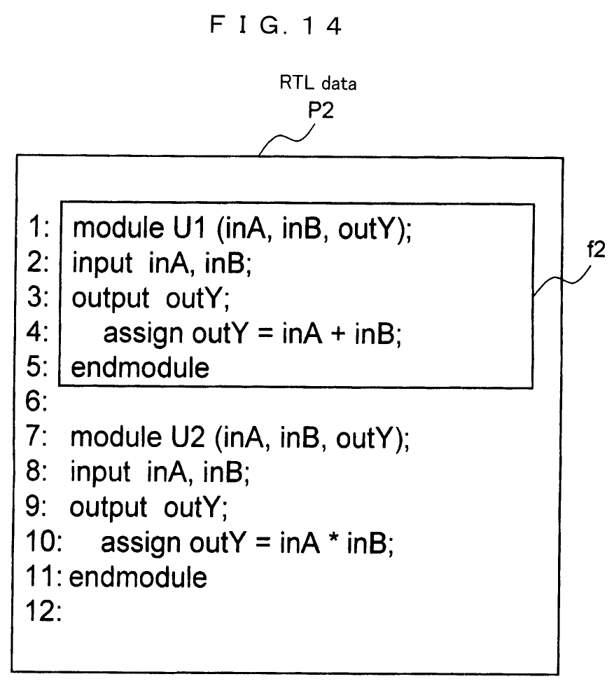

The RTL data displaying device 10 displays the generated RTL data D4 as the text in the same language as that of the RTL description file F3 to be outputted. For example, when the RTL description file F3 to be outputted is written with Verilog language, the RTL data D4 is also written and displayed with the Verilog language in the RTL data displaying device 10. FIG. 14 is an example of the display screen of the RTL data displaying device 10.

The RTL data displaying device 10 is capable of selecting the display RTL data by a unit of functional unit or resource, and a section corresponding to the selected functional unit or the resource is displayed emphatically on the RTL data displaying device 10. In addition, the section corresponding to the selected functional unit or the resource is also displayed emphatically on the data path template displaying device 11.

A simulation result S is inputted to the simulation result input device 12. The simulation result input device 12 generates a signal value transition database DB that is a transition information of the signal value based on the input values (transition information of the signal values) in all the signals written in the data path template TP, based on the inputted simulation result.

The data path template displaying device 11 searches the signal values of the signals written in the data path template TP at the designated time designated by the user, from the signal transition database DB. When the resource is the operation resource, the operation contents executed with the signal value is displayed within the figure of the resource.

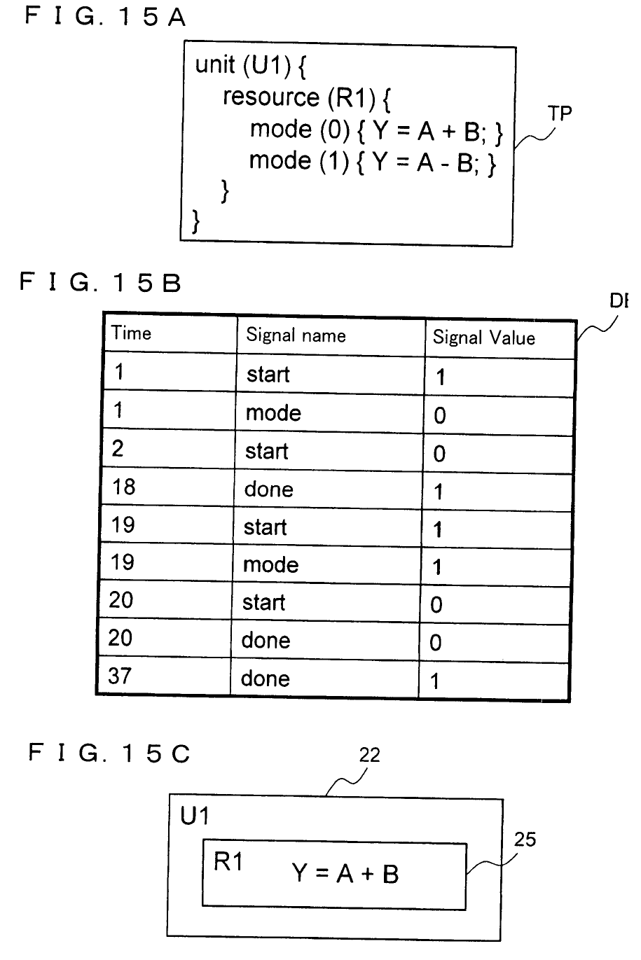

For example, as shown in FIG. 15A-FIG. 15C, when the resource R1 is written in the data path template TP and the time 1 is designated, “0” is obtained as the value of the signal mode at the time 1 from the values stored in the signal value transition database DB. On the display screen of the data path template displaying device 11, “Y=A+B” which indicates the operation contents in the case of signal mode=0 is displayed within the FIG. 25 of the resource R1.

As described above, the third embodiment allows reduction of the work load of the operation designated by the user, through displaying the behavior data D1, designating the section to be divided on the displayed behavior data D1 and designating the corresponding relationship between the functional units.

Further, by displaying the RTL data D4 and displaying the corresponding relationship to the data path template TP, it becomes possible to analyze the circuit of the outputted RTL description more easily.

Furthermore, by analyzing the signal values from the simulation result S and showing the behavior of the resource at the designated time, it is possible to analyze the circuit much more easily.

The present invention has been described in detail referring to the most preferred embodiments. However, various combinations and modifications of the components are possible without departing from the spirit and the broad scope of the appended claims.

What is claimed is:

1. A high-level synthesis method, that generates a register transfer level description from a behavior description based on a reference result obtained with reference to a group of functional units that define a generating method of a circuit with a register transfer level, and a connection relationship of signals between each of functional units that constitute said group of functional units.

2. The high-level synthesis method according to claim 1, wherein said behavior description includes a plurality of behaviors that are not executed simultaneously.

3. The high-level synthesis method according to claim 1, wherein, in each of said functional units, defined are at least one of an operation device, a storage device and an external I/F that are mounting targets at register transfer level respectively, as well as a synthesis rule for generating said register transfer level description from said behavior description.

4. The high-level synthesis method according to claim 3, wherein said operation device comprises a plurality of exclusive functions, and said functional unit comprising said operation device can be corresponded to a plurality of sections in said behavior description.

5. The high-level synthesis method according to claim 3, wherein said storage device is any one of a memory, a register file or an FIFO register.

6. The high-level synthesis method according to claim 3, wherein said external I/F is any one of no-handshake type, one-directional handshake type, or bidirectional handshake type.

7. The high-level synthesis method according to claim 3, wherein a control mode of a circuit generated in said register transfer level description is defined in said synthesis rule.

8. The high-level synthesis method according to claim 7, wherein said control mode defined in said synthesis rule is any one of a sequential processing mode, a pipeline processing mode, or no-control mode.

9. The high-level synthesis method according to claim 1, comprising the steps of:
a step for dividing said behavior description into partial behavior descriptions;
a step for corresponding said partial behavior descriptions to said functional units within said data path template; and
a step for generating said register transfer level description from said partial behavior descriptions.

10. The high-level synthesis method according to claim 2, comprising the steps of:
a step for dividing said behavior description into partial behavior descriptions by each of said plurality of behaviors that are not executed simultaneously;
a step for corresponding said partial behavior descriptions to said functional units within said data path template;
a step for binding a plurality of said partial behavior descriptions into a single partial behavior description, when there are a plurality of said partial behavior descriptions that are correlated to said functional unit; and
a step for generating said register transfer level description from said bound partial behavior description.

11. The high-level synthesis method according to claim 1, further comprising:
a step for selecting said data path template to be referred as an index of at least one selected from a processing cycle number, area, and power consumption from a data path template library where a plurality of said data path templates are registered.

12. A high-level synthesis system, comprising:
a data path template library wherein registration is carried out in advance with respect to data path templates defining a group of functional units where a generating method in a register transfer level of a circuit is given definition, and a connection relationship of signals between each of functional units that constitute said group of functional units;
a selector for selecting said data path template from said data path template library;
a first input device to which said behavior description is inputted; and
a first generator which generates a register transfer level description from said data path template selected by said selector and said behavior description inputted to said first input device.

13. The high-level synthesis system according to claim 12, wherein said first generator comprises:
a divider for dividing inputted said behavior description into partial behavior descriptions;
a corresponding device for corresponding said partial behavior descriptions to said functional units; and
a second generator for generating said register transfer level description from said partial behavior descriptions.

14. The high-level synthesis system according to claim 13, further comprising a binding device for binding a plurality of partial behavior descriptions into a single partial behavior description, when there are a plurality of partial behavior descriptions that are corresponded to said functional unit.

15. The high-level synthesis system according to claim 12, further comprising a register for allowing a user to register a new data path template to said data path template library.

16. The high-level synthesis system according to claim 13, further comprising
a behavior data displaying device for displaying said behavior description, and
a data path template displaying device for displaying selected said data path template, wherein:
said partial behavior description is selected by a user based on displayed contents of said behavior data displaying device;
said functional unit is selected by said user based on displayed contents of said data path template displaying device; and
said selected partial behavior description and said selected functional unit are corresponded to each other.

17. The high-level synthesis system according to claim 12, further comprising
a data path template displaying device for displaying said selected data path template, and
a register transfer level data displaying device for displaying said generated register transfer level description, wherein
when said functional unit is selected based on displayed contents of said data path template displaying device, said register transfer level data displaying device displays emphatically a partial description of said register transfer level description that corresponds to said selected functional unit.

18. The high-level synthesis system according to claim 12, further comprising:
a second input device for inputting a simulation result of said generated register transfer level description; and
a data path template displaying device for displaying behavior of said functional unit at a designated time.
